(19) United States
(12) Patent Application Publication
(10) Pub. No.: US 2012/0259692 A1
(43) Pub. Date: Oct. 11, 2012

(54) Apparatus and Method for Verifying Criteria of Coupon Users

(76) Inventor: Dante Monteverde, Las Vegas, NV (US)

(21) Appl. No.: 13/292,404

(22) Filed: Nov. 9, 2011

Related U.S. Application Data
(63) Continuation-in-part of application No. 13/082,008, filed on Apr. 7, 2011.

(51) Int. Cl. G06Q 30/02

(52) U.S. Cl. 705/14.25; 705/14.66; 705/14.39; 705/14.53

(57) ABSTRACT

A method, system, apparatus and computer program to establish whether a user will likely conduct repeat business with a vendor presenting a commercial offer. If the system determines the user is likely to conduct repeat business with the vendor, the system will present the offer in a first format, and if the system determines the user is less likely do conduct repeat business with the vendor, the system will present the offer in a second format. In the second format, the offer is either more expensive or less prominently displayed as compared to the first format.

### CROSS REFERENCE TO RELATED APPLICATION

The present application is a continuation-in-part of U.S. patent application Ser. No. 13/082,008, filed Apr. 7, 2011, the contents of which are hereby incorporated by reference in their entirety.

### TECHNICAL FIELD OF THE INVENTION

The present invention relates generally to verifying user information, and more particularly to verifying information of online coupon users to establish a likelihood of the user conducting repeat business.

### BACKGROUND OF THE INVENTION

Also, Internet-based “deal of the day” coupon offerings have become popular in recent years. Discounts of this sort are typically sent in deal of the day coupons to members of a predetermined list. If a sufficient number of people agree to the group discount, the group discount becomes available to all members of the list. However, if the predetermined threshold of people do not agree to the group coupon, the deal will not become available to the members of the list. This business model has been successful in that it allows a large group to receive discounted offers for products or services, while allowing businesses to require a predetermined number of users to accept the discount so that their product or service may be sold in bulk.

The conventional online coupon is part of a business model that attempts to attract repeat customers with the initial coupon or commercial offer. Some vendors actually lose money when customers accept the commercial offer, but the vendors hope to make back the loss in future repeat business. In other words, the main purpose of a conventional commercial offer such as an online coupon is to entice the potential customer to the vendor's establishment to try the vendor's goods or services, with the hope that the user will be happy with the goods or services received through the offer and return to the vendor in the future without the enticement of additional commercial offers. Accordingly, while the vendor may lose money by honoring the initial offer to the customer (e.g., if the offer is for buy one, get one free, the vendor must pay for the product that was provided for free), the commercial offer is a premise for repeat, future business of the customer.

Many customers take advantage of commercial offers by accepting the commercial offer but not providing any repeat business to the vendor. For example, customers may live outside of a geographic area where the vendor is located, or may otherwise have a habit of shopping with the vendor only when accepting the commercial offer. However, if a potential customer is not likely to frequent the vendor's establishment in the future, the vendor may lose money by honoring the offer with the customer and without obtaining future business from that customer.

By their nature, group coupon deals encourage users to recommend the coupon to their peers so that a required minimum number of users utilize the deal, thereby increasing the vendor's customer base exposure. In other words, customers who purchased the deal generate additional customers for the vendor by “word of mouth” advertising in order to ensure that the minimum number of group coupons will be sold and the group coupon will be usable. Therefore, the conventional group coupon system uses the fear of a possible failed deal as a marketing technique to increase the number of purchasing customers for the vendor. However, this incentive can sometimes work too well-producing a large increase of customers for the vendor for a short period of time, which can overwhelm the vendor during the relevant coupon period (e.g., the vendor does not have adequate staffing or inventory to meet the coupons' demand).

### BRIEF SUMMARY OF THE INVENTION

The present application discloses a system that presents the commercial offer to a user in one of at least two formats based on the likelihood of the user providing repeat business. If the system determines that the user is unlikely to conduct repeat business, the system can present the offer to the user in a more expensive or less prominently displayed format as compared to when the system determines that the user is likely to conduct repeat business.

The present application also discloses a system and method where coupons or other advertisements are transmitted to potential customers in a controlled time-released fashion to minimize the possibility of overwhelming the staff and/or inventory of the vendor during the time period that the coupon can be utilized. In an embodiment, sets of coupons or advertisements can be available for distribution, wherein a first set can be distributed to a first subset of users during a pre-selected time period. Then, during a different pre-selected time period, a second set can be distributed to a second subset of customers. The deal can be then be sent to groups of customers over selected and controlled periods of time, rather than simultaneously transmitting the offer to all customers and overwhelming the vendor with a large surge in business.

In another embodiment, the sets of coupons or advertisements can be simultaneously transmitted to all customers, but each of the sets of coupons or advertisements has different time periods of usability. For example, a first set of coupons sent to a first subset of customers may be usable only on Monday, wherein a second set of coupons sent to a second subset of customers may be usable only on Tuesday, even though both subsets of customers received the coupon or advertisement at the same time. The time-released deal system can further require that the customer refer the deal to a predetermined number of other customers before the customer can utilize the deal, in a sort of recruitment program.

In particular, the present application discloses a method of presenting a commercial offer to a user including establishing a geographic point of interest of the user; determining a target area based on the geographic point of interest; collecting a commercial offer from a vendor; determining whether the vendor of the commercial offer is associated with the target area; presenting the commercial offer to the user in a first format if the commercial offer is associated with the target area, and presenting the commercial offer in a second format if the commercial offer is not associated with the target area, wherein at least one of the steps of establishing, determining, collecting, allowing, determining, and presenting is performed by a processor.

Also disclosed is an apparatus for receiving a commercial offer from a vendor including a computer-readable medium adapted to store data; a processor that executes a computer program to determine a target area of a user based on at least one of a geographic point of interest input by the user and a geographic point of interest that is determined by the computer program; a transceiver adapted to communicate information identifying the target area to an external server and receive a transmitted commercial offer from the server, wherein the commercial offer is from a vendor associated the target area; and a display adapted to present the commercial offers to the user, wherein the processor is adapted to cause the transmission of the commercial offer to the user in a first format if the commercial offer is associated with the target area, and is further adapted to cause the transmission of the commercial offer in a second format if the commercial offer is not associated with the target area.

Also disclosed is a method of presenting commercial offers from a vendor to a user including allowing the user to request a first commercial offer from a server; recording whether the user conducts repeat business a predetermined number of times with the vendor after receiving the first commercial offer; allowing the user to request a second commercial offer from the server after the user requests the first commercial offer from the server; presenting the second commercial offer to the user in a first format if the user conducted repeat business with the vendor a predetermined number of times after receiving the first commercial offer, and presenting the second commercial offer to the user in a second format if the user conducted repeat business with the vendor fewer than a predetermined number of times after receiving the first commercial offer, wherein at least one of the steps of allowing, recording, allowing and presenting is performed by a processor.

A method of presenting a commercial offer to a user is also disclosed and comprises establishing a geographic point of interest of the user by allowing user input of specific locations into a database; determining a target area based on the geographic point of interest; collecting a commercial offer from a vendor; determining whether the vendor of the commercial offer is associated with the target area; presenting the commercial offer to the user in a first format if the commercial offer is associated with the target area, and presenting the commercial offer in a second format if the commercial offer is not associated with the target area; and verifying the target area by a member selected from the group consisting essentially of sending a certified letter, obtaining identifying information from a card of the user, and obtaining identifying information from a utility organization doing business with the user, wherein at least one of the steps of establishing, determining, collecting, allowing, determining, and presenting is performed by a processor.

### BRIEF DESCRIPTION OF THE DRAWINGS

For the purpose of facilitating an understanding of the subject matter sought to be protected, there is illustrated in the accompanying drawing embodiments thereof, from an inspection of which, when considered in connection with the following description, the subject matter sought to be protected, its construction and operation, and many of its advantages should be readily understood and appreciated.

FIG. 1 is a schematic diagram of an embodiment of the present invention;

FIG. 2 is a schematic diagram illustrating the hardware components of the user device of the present invention;

FIG. 3 is a flow chart of an embodiment of the present invention depicting a method for presenting relevant commercial offers to a user;

FIG. 4 is a flow chart of an embodiment of the present invention depicting a method for determining a geographic point of interest of the user;

FIG. 5 is a flow chart of an embodiment of the present invention depicting a method for determining a target area based on the established geographic points of interest of the user;

FIG. 6 is a flow chart of an embodiment of the present invention depicting a method of presenting relevant commercial offers to a user based on a pre-established target area of the user;

FIGS. 7(a)-(c) are illustrations of a display showing several geographic points of interest of the user;

FIG. 8(a) is an illustration of a display showing a user-modified target area based on the user-inputted geographic points of interest;

FIG. 8(b) is an illustration of a display showing a completed custom target area; and

FIG. 9 is a flow chart of an embodiment of the present application depicting a method that determines whether the user is likely to conduct repeat business with the vendor.

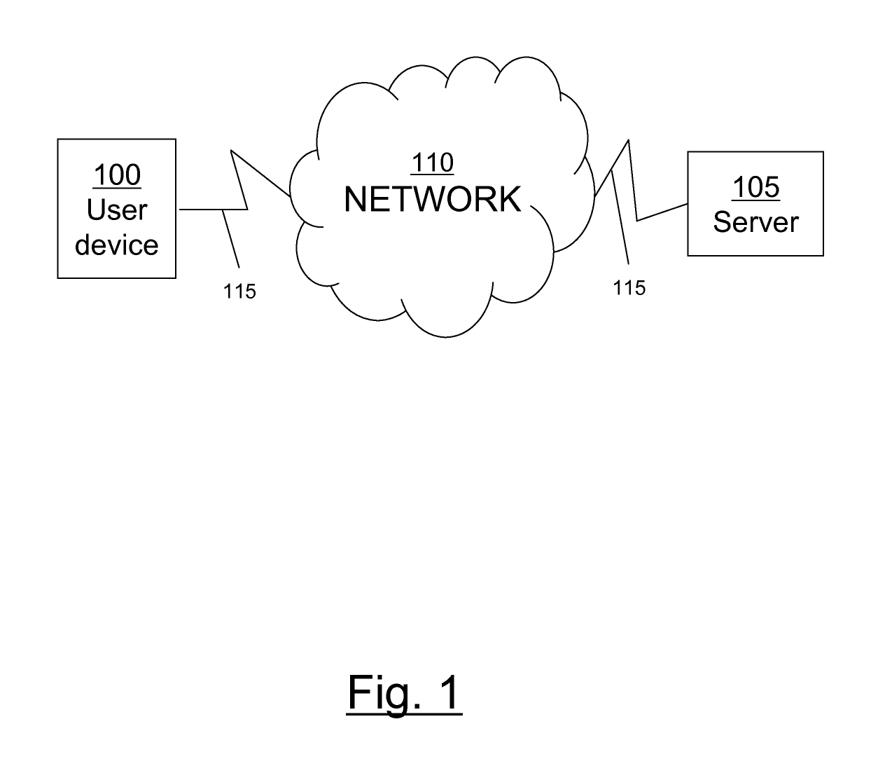

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

The present application discloses an apparatus, method, system and computer program for facilitating commercial transactions between businesses and users located within a custom-designated target area. In an embodiment, a user device 100 may be connected to a server 105 via a network 110 by way of communication links 115, such as, for example, the Internet. The user device 100 communicates with the server 105 to transmit data to and receive data from the server 105. Such data can include search queries from the user, commercial offers received from the server 105 to the user device 100, the vendor's position in the search results based on a pay-for-placement auction, counteroffers from the user device 100 to the server 105, and data that depicts the geographic points of interest of the user or the target area of the user, for example.

As used herein, the term “pay-for-placement” can refer to an auction or flat payment transaction where a vendor can bid on the placement of their website or commercial offer within a string of search results. A higher bid from the vendor can cause a website to be displayed prominently within the search results, e.g., by displaying the website first or near the top of the list of search results, by displaying the website in font larger than font used to display websites of lower bids, by placing higher bid websites in bold, underline or italics, by displaying the name of higher bid websites in a color more visible to a user (e.g., red), or by displaying higher bid websites using a picture while lower bid websites are displayed in text only, for example. Any other manner of displaying images or text more prominently can be used within the pay-for-placement auction without departing from the spirit and scope of the present application.

As used herein, the term “bid” can refer to a flat amount of money paid to the search engine or a portion of the discount offered to the consumer (e.g., a dollar amount). Instead of paying the search engine a guaranteed amount of money, a vendor can also “bid” for placement by offering a portion of the discount offered to the buyer, referred to herein as a discount proposal. In this exemplary pay-for-placement auction, the commercial offers will be displayed in an order corresponding to the discount amount offered (i.e., highest discount first, second highest discount second, and so forth). The search engine can receive a commission as a portion of the discount offered to the potential buyer. For example, if a buyer searches for pizza within his or her target area, and Domino's® offers a ten dollar discount compared to a five dollar discount offered by Papa Johns®, Domino's® discount will be displayed first. However, of the ten dollar discount offered by Domino's®, five dollars will be distributed to the potential buyer and five dollars will be distributed to the search engine as a commission. Of course, the commission can be any amount of the discount offered to the potential buyer.

Geographic points of interest to the user can include any geographic point and can be determined either manually by user input or automatically if the user has not input any custom geographic points of interest. By way of example, common geographic points of interest may include the location of the user's home, the location of the user's work, the location of the user's children's school, the location of the user's church, synagogue, mosque, or other place of worship, restaurants or other businesses commonly frequented by the user, or any other location that may help define the routine of the user and/or the locations where the user is likely to do business. It will be understood that the intent is that the preferred geographic points of interest are those points where the user typically travels to and/or from, although any points of interest can be included, such as, for example, a location where the user is going on a vacation. As discussed below, based on the geographic points of interest of the user, the embodiments of the present application determine a target area that more closely identifies an area that the user is likely to frequent and conduct business. Accordingly, pay-for-placement bids and coupon offers can be more closely tailored to a target consumer audience that is more likely to accept the commercial offers of, or conduct business with, the vendor.

Commercial offers can include any offer from a vendor or consumer that is capable of being transmitted over the network 110, or any representation of the vendor's business. As used herein, a consumer offer can be a listing of a website in a list of search results, a coupon offer, a list of prices for relevant products or services, or any other means of communicating a potential commercial transaction.

The user device 100 can be a device of any type that allows for the transmission and/or reception of data. By way of example, the user device 100 can include a smart phone (e.g. iPhone®), personal computer, voice and video telephone set, streaming audio and video media player, integrated intelligent digital television receiver, DVS receiver, work station, radio, personal digital assistant (PDA), mobile satellite receiver, GPS receiver, software system, social network or any combination of the above.

The server 105 can also be a device of any type that allows for the transmission and/or reception of data, and that is capable of storing information to be transmitted to the user device 100. For example, the server 105 can include any device listed above with respect to the user device 100, or can include a non-transitory computer-readable recording medium, such as a hard drive, DVD, CD, flash drive, volatile or non-volatile memory, RAM, or any other type of data storage. As used throughout this application, the term “non-transitory computer-readable recording medium” excludes only signals and carrier waves, per se, and is not meant to exclude other types of memory that may be considered “transitory” such as RAM or other forms of volatile memory.

The network 110 may be a single network or a plurality of networks of the same or different type. For example, the network 110 may include a local telephone network (such as a Bell Atlantic telephone number) in connection with a long distance network (such as an AT&T long distance telephone network). Further, the network 110 may be a data network, an Intranet, the Internet or a telecommunications network in connection with a data network. Any combination of telecommunications and data networks may be used without departing from the spirit and scope of the present application. For purposes of discussion, it will be assumed that the network 110 is the Internet.

The communication links 115 may be any type of connection that allows for the transmission of information. Some examples include conventional telephone lines, fiber optic lines, direct serial connections, cellular telephone connections, satellite communication links, local area networks (LANs), intranets, and the like.

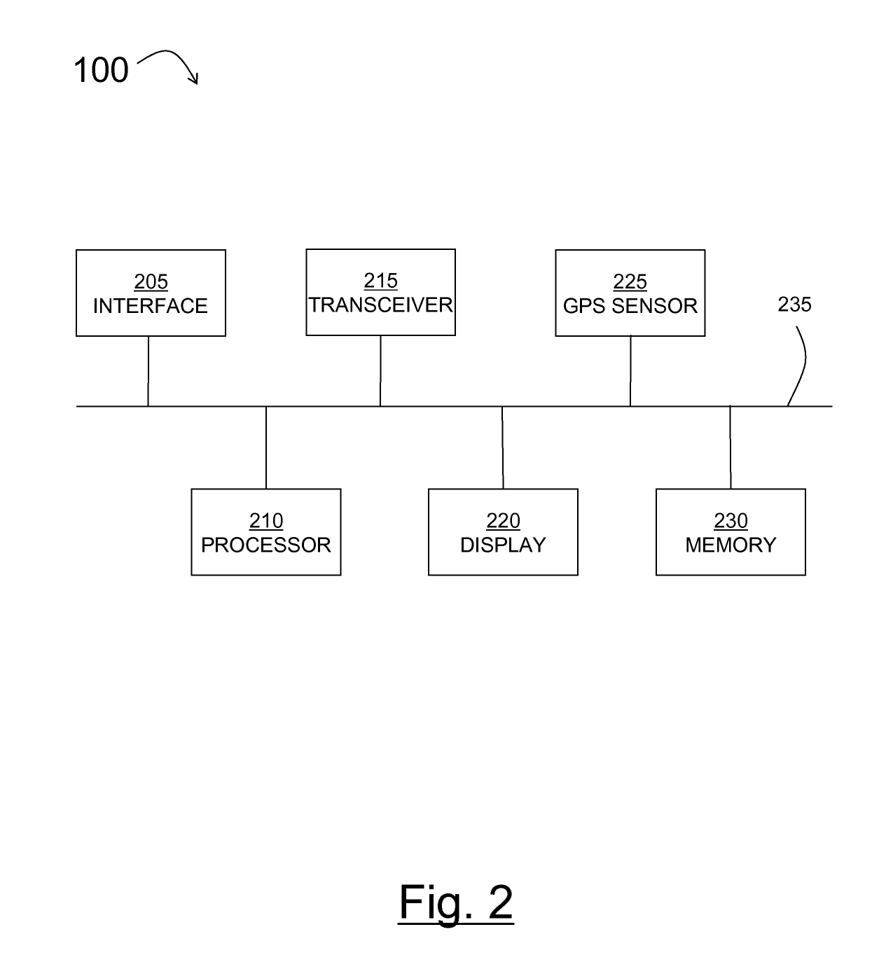

FIG. 2 is a schematic diagram illustrating the hardware components of the user device 100. As shown, the user device 100 can include an interface 205, processor 210, transceiver 215, display 220, GPS sensor 225 and a memory 230 connected via a bus 235.

The interface 205 allows the user to input information or commands into the user device 100 and to transmit the information or command to the server 105 via the network 110. By way of example, the interface can include a keyboard, mouse, touch screen, audio recorder, audio transmitter, member pad, or any other device that allows for the entry of information from a user.

The processor 210 facilitates communication between the various components of the user device 100. The processor 210 can be any type of processor or processors that alone or in combination facilitate communication within the user device 100 and, together with the transceiver 215, transmit information from the user device 100 to external devices. For example, the processor 210 can be a desktop or mobile processor, a microprocessor, a single-core or a multi-core processor.

The transceiver 215 can be any device that can transmit data from the user device 100 or can receive data within the user device 100 from an external data source. By way of example, the transceiver 215 can be any type of radio transmission antenna, cellular antenna, hardwired transceiver, or any other type of wired or wireless transceiver that is capable of communicating with an external device.

The display 220 can display various information for the user to view and interpret, including commercial offers, a search engine interface, search engine results, or requests for the user to input information via the interface 205. By way of example, the display 220 can include a liquid crystal display (LCD), organic light emitting diode (OLED) display, plasma screen, cathode ray tube display, or any other kind of black and white or color display that will allow the user to view and interpret information on the user device 100.

The GPS sensor 225 can allow the user device 100 to determine its current GPS coordinates and thus determine the user's geographic orientation. As discussed below, the GPS coordinates of the user device 100 can be used to determine various geographic points of interest of the user without having a prompt the user to manually input such geographic points of interest.

The memory 230 can store any information including commercial offers or search results received from the server 105 via the network 110. The memory 230 can also store an operating system for the user device 100 or any other software or data that may be necessary for the user device 100 to function. Similar to the server 105 discussed above, the memory 230 can include any non-transitory computer-readable recording medium, such as a hard drive, DVD, CD, flash drive, volatile or non-volatile memory, RAM, or any other type of data storage.

The bus 235 acts as the internal circuitry of the user device 100 that electrically connects the various hardware components of the user device 100. The bus 235 can be any structure that performs such a function.

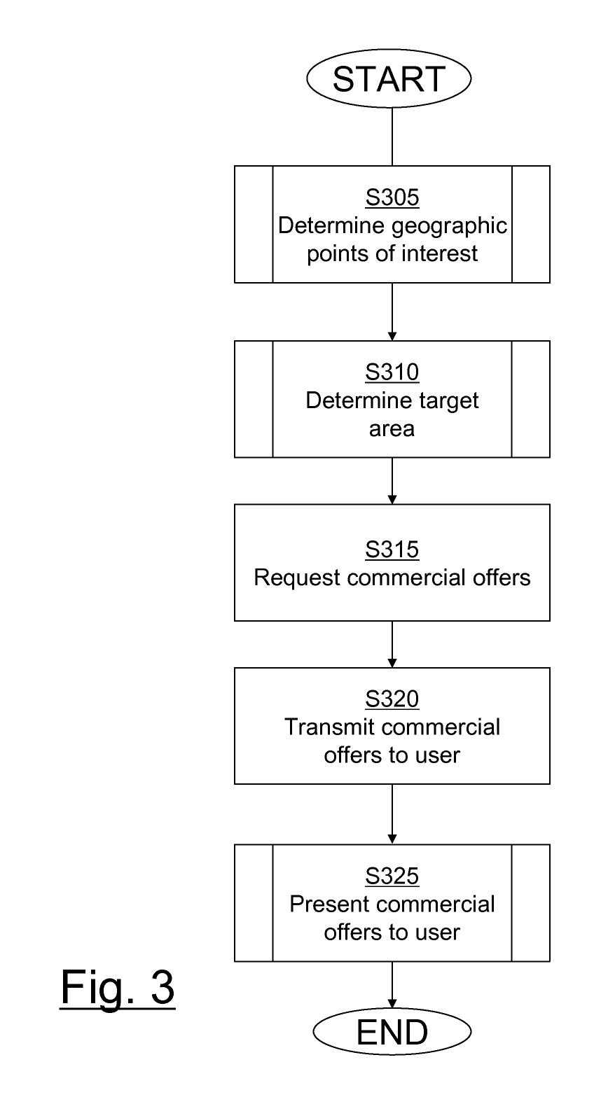

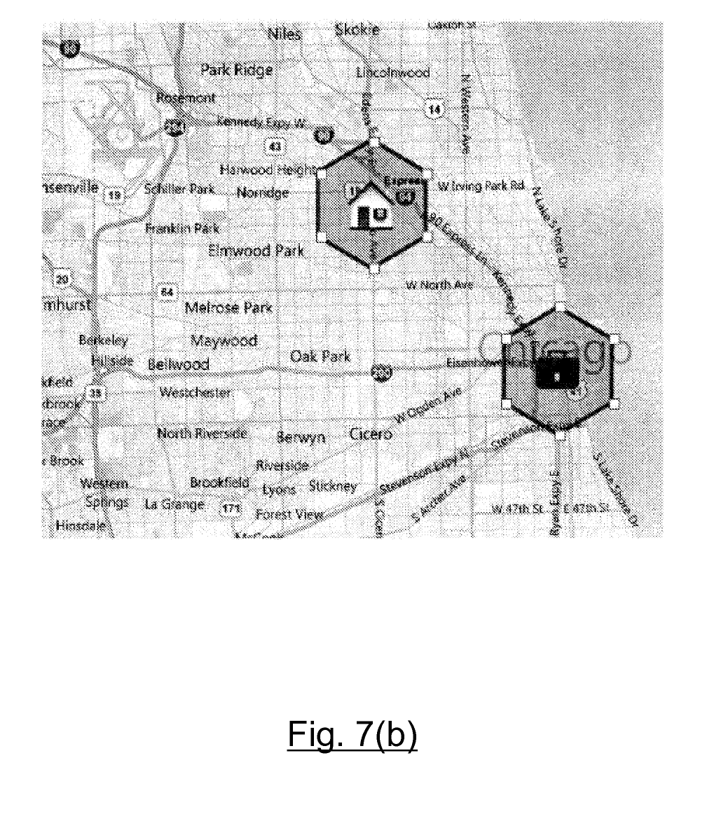

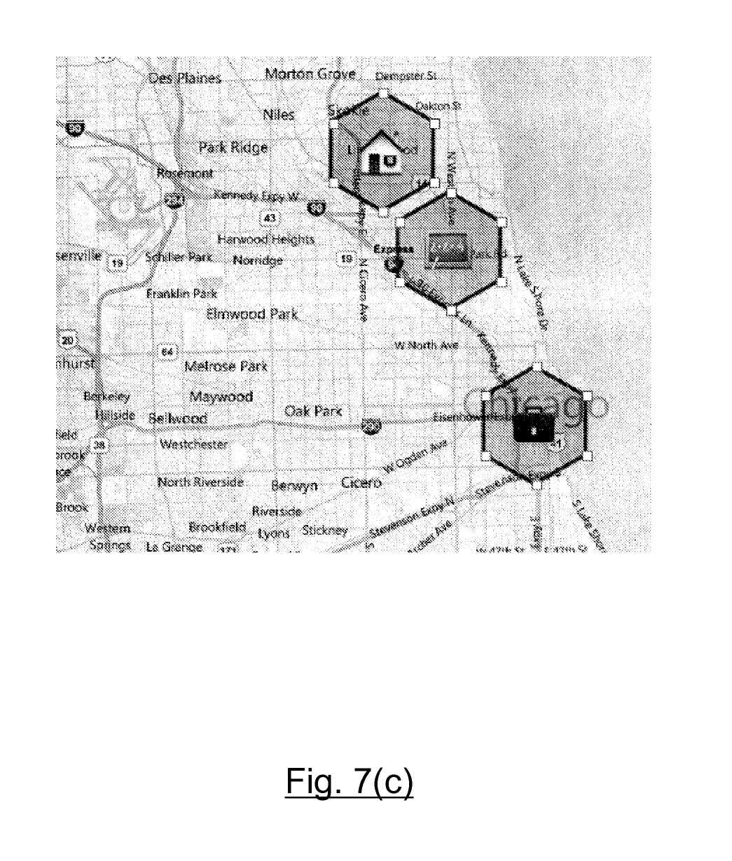

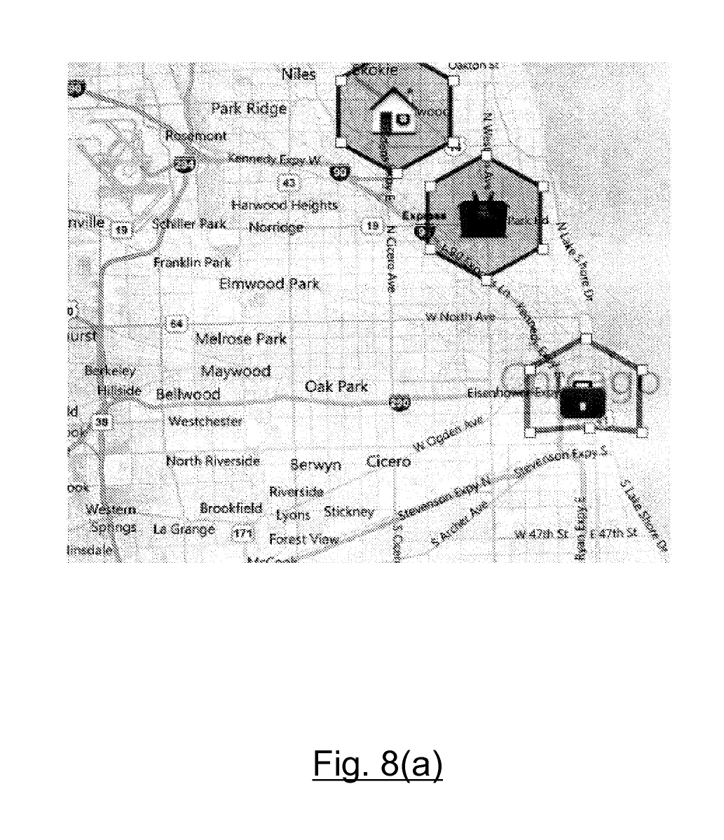

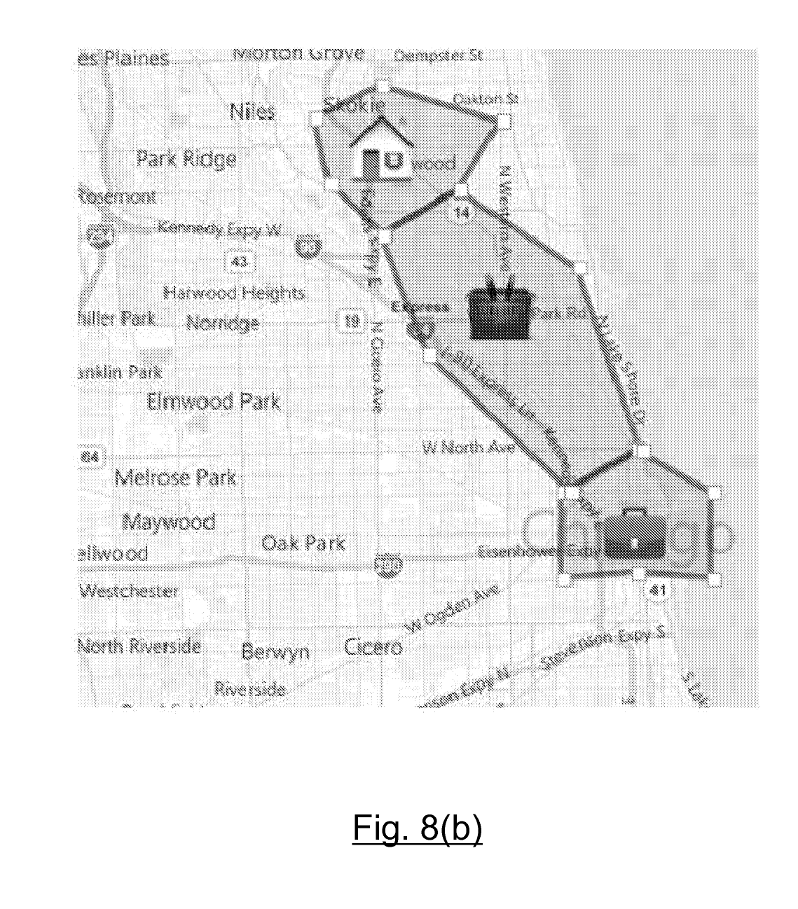

FIG. 3 discloses a flow chart depicting one embodiment of the present invention in which commercial offers are efficiently transmitted and presented to relevant potential buyers based on their preferred, typical geographic points of travel. The process starts at S305, where geographic points of interest are determined by either manually asking the user to input the geographic points of interest or by automatically determining the geographic points of interest based on various factors. As discussed above, the geographic points of interest represent specific locations in which the user is likely to travel based on his or her routine and/or based on areas that the user commonly frequents. Moreover, the geographic points of interest can be modified by typical click-and-drag capabilities and can be represented in any shape. Therefore, while the geographic points of interest are shown as sexaganol in FIGS. 7 and 8, it will be appreciated that other shapes can be used, such as, for example, circular, square, rectangular or polyagonal. Moreover, the size of the shape can also be modified, in order to represent the relevant geographic search area. For example, a circular shape could represent a 5 mile radius from a particular point of interest, wherein businesses within the 5 mile radius would have their results displayed to the user, and businesses outside of the 5 mile radius would not be displayed since it is unlikely the user would conduct business with that business. Moreover, the points of interest can further be interconnected to designated preferred travel corridors when the user travels between the different points of interest. For example, the home point of interest can be interconnected with the work point of interest, wherein geographically relevant businesses along the designated travel route may be provided to the user.

Once the geographic points of interest are established in S305, the process proceeds to S310, where the target area can be determined based on the established geographic points of interest. The target area can be an area that depicts where the user frequently is located or travels based on his or her routine in a broader sense than that depicted in S305 with respect to the geographic points of interest. As discussed below, the target area may be modified by the user or may be automatically modified by the user device 100 to provide a more narrowly-tailored target area for the particular user.

Once the target area has been determined in S310, commercial offers can be requested in S315 by the user device. For example, the user device 100 can enter various search terms into a search engine so as to request commercial offers or business websites in the particular search engine. Alternately, the user device 100 can request commercial offers through an on-demand type methodology in which the user knows in advance from which vendor he or she would like to request a commercial offer. Although FIG. 3 illustrates the user entering various search terms in a search engine after the target area has been established, the order of this process can vary. For example, the user can enter search queries prior to establishing a target area,

After the commercial offers have been requested in S315, the commercial offers for vendors located in the target area where the user is located or commonly travels can be transmitted to the user in S320. The transmitted commercial offers can originate either from the server 105 or anywhere else within the network 110, for example, on an external user device 100 within a peer-to-peer network.

Once the commercial offers are transmitted to the user in S320, the commercial offers can be presented to the user in S325. The manner in which the commercial offers are presented to the user is not limited, and can include displaying the commercial offers on the display 220 or emitting an audio signal communicating the commercial offers. Once the user receives and hears or views the commercial offer, the user can accept the offer by traveling to the location of the business within the target area or by electronically accepting the offer on the user device 100.

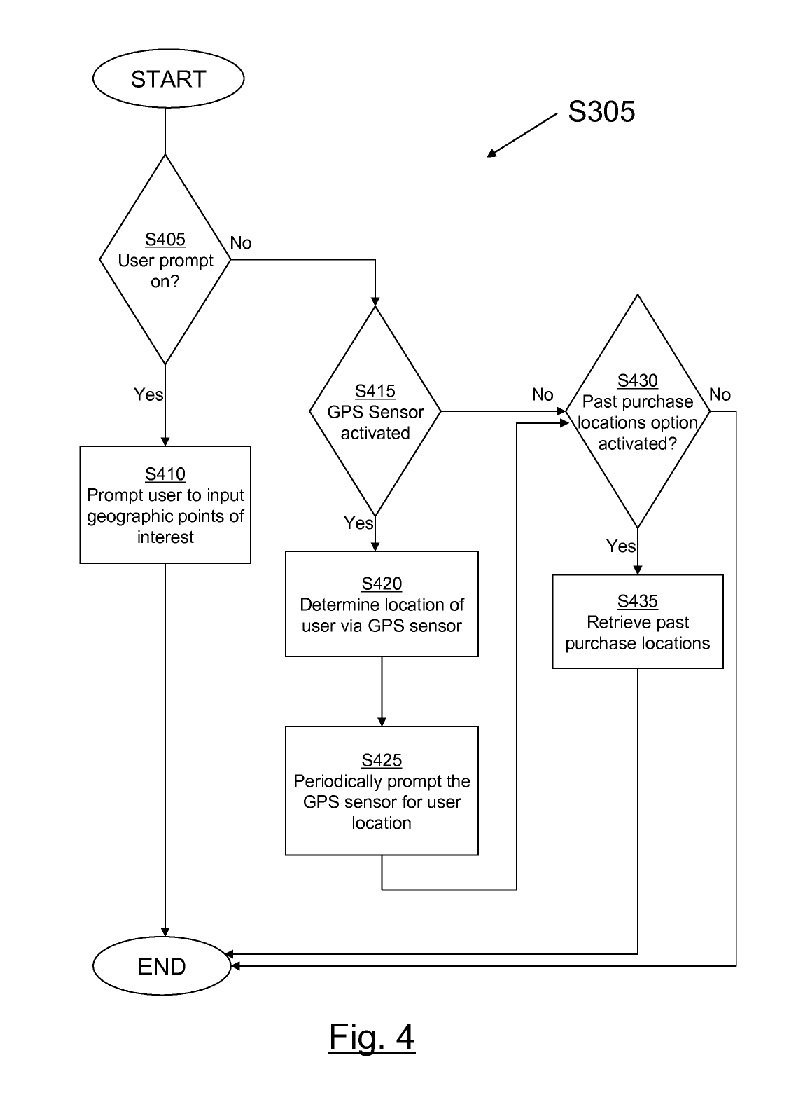

FIG. 4 is a flow chart illustrating a more detailed description of S305, in which geographic points of interest are determined. The process starts at S405, where it is determined whether a user prompt is currently activated. If the user prompt is activated, the process proceeds to S410 where the system prompts the user to input geographic points of interest. For example, the system may prompt the user to input a location of the user's home, the user's work, the location of the user's children's school, or any other locations that the user frequently visits. After the user enters the geographic points of interest, the manually input geographic points of interest are established as the geographic points of interest and the process according to S305 ends.

If the user prompt is not activated, the user device 100 can automatically determine geographic points of interest based on various factors discussed below. Each of these factors may be toggled on or off as desired by the user to provide a more custom-tailored list of geographic points of interest. For example, as shown in FIG. 4, if the user prompt is not on, the process determines whether the GPS sensor has been activated in S415. If the GPS sensor has been activated, the process proceeds to S420, in which the location of the user is determined via the GPS sensor. The user location determined in S420 can be established as a geographic point of interest either separate from or in addition to other geographic points of interest established based on other factors. Alternately, or in addition to the above, the server 105 and/or the network 110 can prompt the GPS sensor for the user location, as depicted in S425. Following this process, or if the GPS sensor is not activated, the process proceeds to S430.

In S430, it is determined whether the past purchase locations option has been activated within the user device. This option determines the past locations that the user has purchased goods or services under the assumption that a user is more likely to purchase goods or services in locations where he or she has previously conducted consumer transactions. If the past purchase locations option is activated, the process proceeds to S435 where the user device 100 retrieves past purchase locations from the server 105, the memory 230, or another storage device within the network 110. For example, the user device 100 itself may store in the memory 230 various purchase locations that were manually or automatically input into the memory 230. The user device 100 can also retrieve from the server 105 or another data storage device on the network 110 information from the user's credit card company, bank, or other commercial organization (e.g., PayPal®) to determine the exact location in which the user purchased items in the past. Once the geographic point of interest has been determined in S435, the process according to S305 ends. Alternately, if the past purchase locations option is not activated, the process according to S305 ends without attempting to retrieve the past purchase locations as depicted in S435.

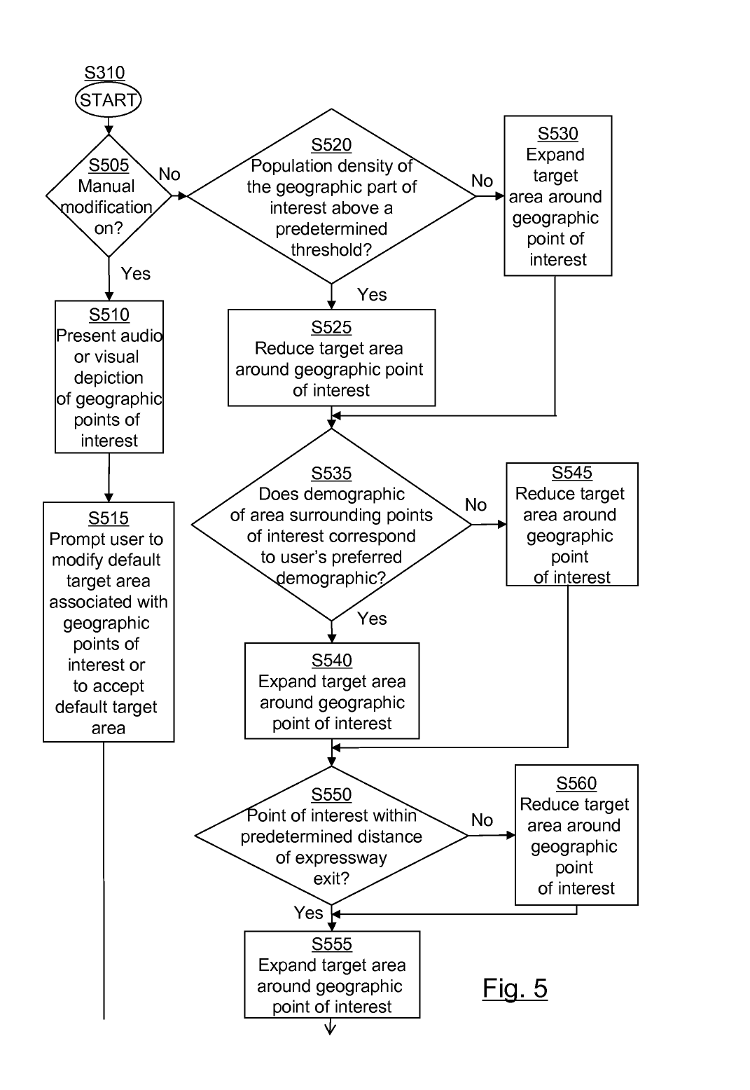

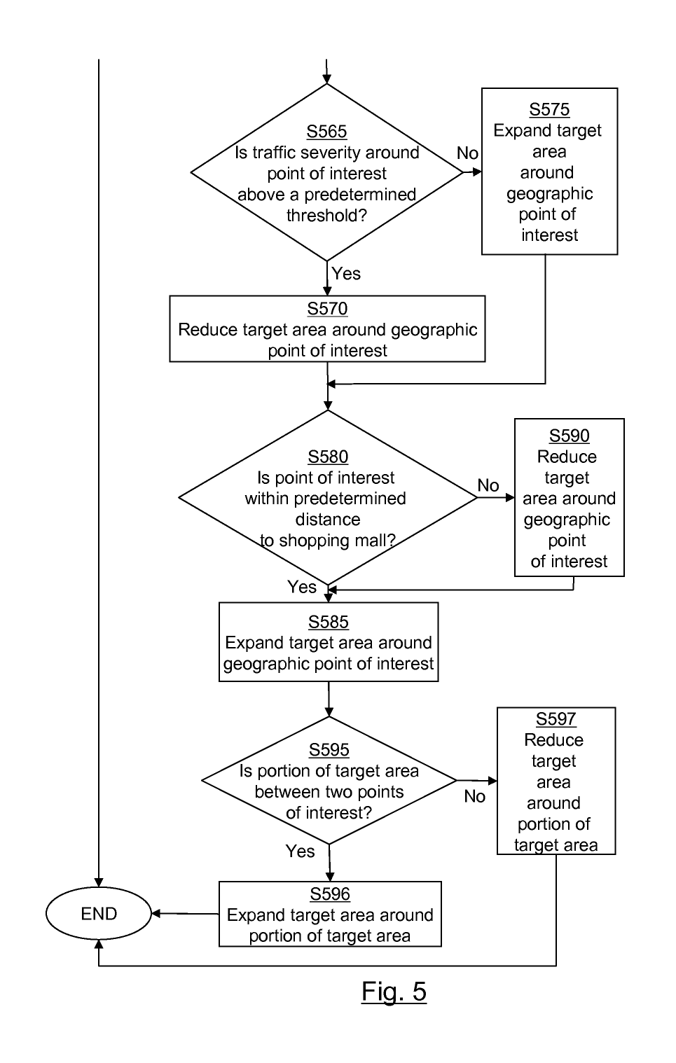

FIG. 5 illustrates a flow chart in which the target area is generated according to S310 based on the geographic points of interest that have been established in S305, as discussed above. The process begins at S505, where it is determined whether the manual modification option is on. If the manual modification option is on, the process proceeds to S510, where audio or visual depictions of the geographic points of interest are presented to the user. For example, the user can view the visual depiction of the geographic points of interest on a map so the user can determine the types of manual modifications are desired to more closely tailor the target area to the user's unique travels and locations. In S515, the user device 100 prompts the user to modify the default target area associated with the geographic points of interest or to accept the default target area without modification. The default target area can include a predetermined radius surrounding the geographic point of interest, e.g., a three mile radius surrounding the geographic point of interest. The user can then modify the target area associated with the geographic point of interest or accept the default target area in S515. The user may wish to modify the target area based on any factor considered important to the user. For example, if the default three mile radius surrounding the geographic point of interest causes the target area to encompass an area of high crime, the user can modify the target area using a mouse or other input device on the interface 205 so that the high crime area is excluded from the target area. Following S515, the process according to S310 ends and the target area is established based on the target area modified or accepted by the user in S515.

If manual modification is not activated, the process proceeds to S520, wherein the automatic modification of the target area begins. It should be noted that any of the factors discussed below with respect to the automatic modification of the target area can be toggled on or off as desired by the user.

In S520, it may be determined whether the population density of the geographic point of interest is above a predetermined threshold. If the population density surrounding the geographic point of interest is above the predetermined threshold, the process proceeds to S525, wherein the target area surrounding the geographic point of interest is reduced. However, if the population density surrounding the geographic point of interest is below the predetermined threshold, the process proceeds to S530, wherein the target area surrounding the particular geographic point of interest is expanded. The reasoning for the above modification is because a user is typically more inclined to travel longer distances to reach their destination or their desired business locations when the user is traveling or located in a rural environment. Thus, S520 automatically modifies the target area according to this principle.

Once the population density of the geographic point of interest is analyzed, the process may proceed to S535, where the demographic of the area surrounding the points of interest is analyzed to determine whether it corresponds to the user's preferred demographic. If the geographic point of interest corresponds to the user's preferred demographic, the process proceeds to S540, wherein the target area is expanded around the geographic point of interest. Alternately, if the demographic of the area surrounding the points of interest does not correspond to the user's preferred demographic, the process proceeds to S545, wherein the target area around the geographic point of interest is reduced. The demographic of the geographic point of interest is analyzed because many users are more likely to travel to areas in which they share the same age, income level, or ethnic/religious background. Also, a person may enjoy food of a particular ethnicity, and thus may wish to have a target area encompass neighborhoods with restaurants associated with this ethnicity. Once the demographic surrounding the geographic point of interest has been analyzed, the process proceeds to S550.

In S550, it may be determined whether the geographic point of interest is within a predetermined distance of an expressway or highway exit. If the geographic point of interest is within a predetermined distance of an expressway or highway exit, the target area is expanded around the geographic point of interest, as depicted in S555. Otherwise, the target area around the geographic point of interest is reduced as depicted in S560. The reasoning for this analysis is because consumers tend to shop more around areas close to expressway or highway exits because the consumer can easily get to and from their destination by way of the expressway or highway located close to the business of interest.

To avoid the target area being in an area of heavy traffic, the traffic severity surrounding the geographic point of interest may be analyzed to determine whether it is above a predetermined threshold. If the traffic severity is above the predetermined threshold, the process may proceed to S570, wherein the target area is reduced in an attempt to avoid severe traffic. If the traffic severity is below the predetermined threshold, the target area will be expanded so as to encompass areas of low traffic.

After the traffic severity has been analyzed, the process may proceed to S580, where it is determined whether the geographic point of interest is within a predetermined distance to a shopping mall, under the presumption that consumers are more likely to shop in an area of high concentration of vendors, rather than in an area where the vendors are spread out and the user is required to travel more to get from one vendor to another. If the geographic point of interest is within a predetermined distance to a shopping mall, the process may proceed to S585 and expands the target area so as to encompass more areas that have a high concentration of vendors. If the geographic point of interest is not within the predetermined distance to a shopping mall, the process may proceed to S590, wherein the target area surrounding the geographic point of interest is reduced.

Finally, the process according to S310 may proceed to S595 where it may be determined whether a portion of the target area is between two geographic points of interest. This process assumes that a consumer is more likely to purchase a product or service at a business located between two major points of their commute, e.g., between home and work. Accordingly, if the portion of the target area is located between two of the geographic points of interest, the process expands the target area around the portion located between the two points of interest at S596. If the portion is not between the two geographic points of interest, the process may reduce the target area in a region that is not located between the geographic points of interest.

Following either the manual and/or automatic analysis, the process according to S310 is complete and the target area is established for the user. Accordingly, the process according to S310 ends following the manual and/or automatic analysis of the geographic points of interest.

It is noted that many of the above modifications were discussed as being made to geographic points of interest rather than to sections of the target area that are not necessarily geographic points of interest. It should be noted that any of the above manual or automatic modifications can be made either to an established geographic point of interest or a portion of the target area that is not input by the user or determined automatically by the user device 100 to be a geographic point of interest. For example, a specific portion of the target area between the user's home and work can be analyzed to determine whether that specific portion of the target area is above or below the predetermined population density threshold according to S520.

It is also noted that many of the automatic modifications assume that the user will choose either an automatic or manual modification process, but not both. However, it should be noted that the user can have sole discretion to either manually or automatically, or both manually and automatically modify his or her target area depending on factors relevant to his or her routine. In addition, the modifications can be expanded or reduced variably. For example, the user may choose to expand his or her target area by a one mile radius if the portion of the target area or geographic point of interest is above the predetermined threshold for the population density in accordance with S520, but may choose to expand or reduce the target area surrounding the geographic point of interest or a portion of the target area by three miles if the demographic of that area matches the preferred demographic of the user. It will further be appreciated that the present invention can operate with one or more of the above-described automatic or manual modifications, and not all. Accordingly, each above described automatic or manual modification is optional, exemplary and non-exhaustive.

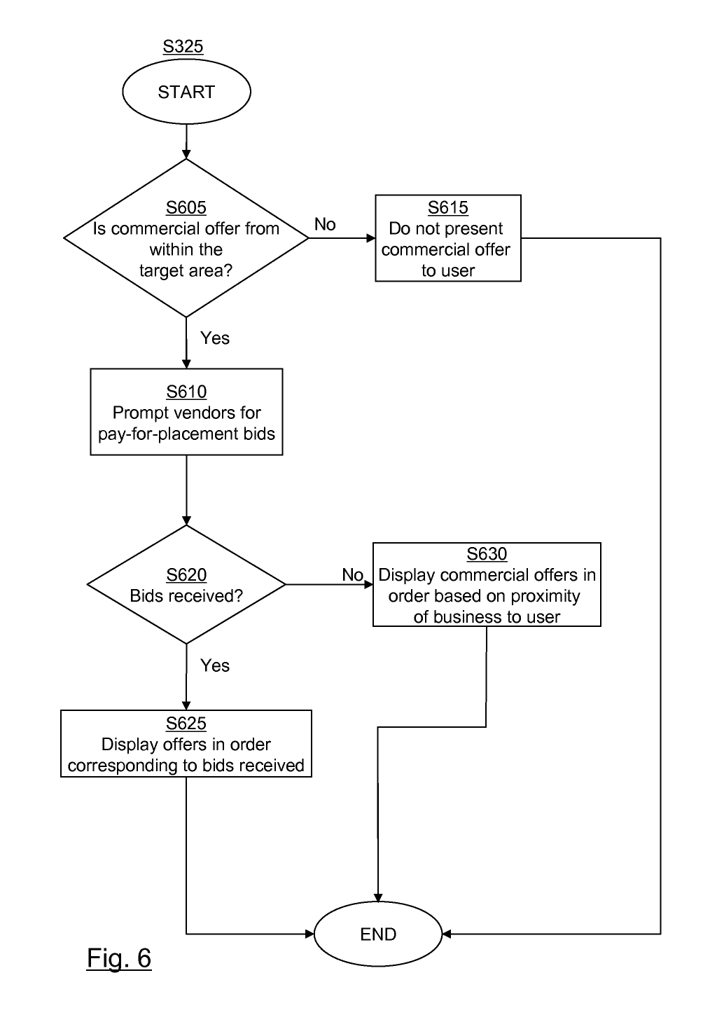

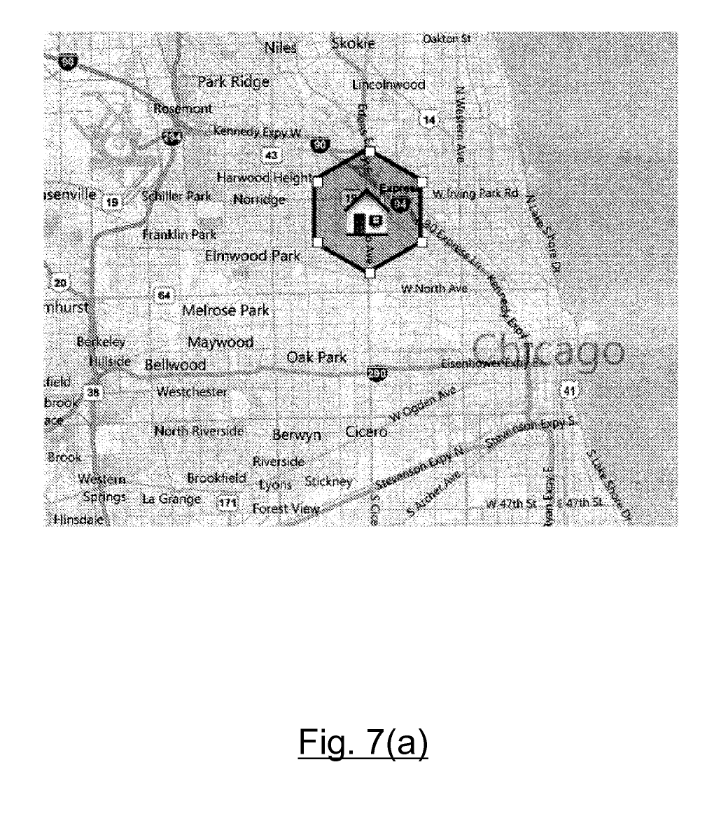

FIG. 6 discloses a flow chart depicting a more detailed illustration of the process of presenting commercial offers to a user in S325. Once the process reaches S325, a target area has already been established (in S310) and the user has requested commercial offers or searched for a website through, for example, a search engine (in S315). The process of S325 focuses primarily on how the received commercial offers or searches are presented to the user based on a pay-for-placement methodology.

The process begins at S605 in which either the user device 100 or the server 105 determines whether the commercial offer is within the target area determined in S310. If the commercial offer is within the target area, the process proceeds to S610 in which commercial offer results are displayed to the user. If the commercial offer is not within the target area, the process proceeds to S615, in which the commercial offer is not presented to the user and the process according to S325 ends.

In S610, the vendors are prompted for pay-for-placement bids where the highest vendor bid will cause that particular vendor's commercial offer or business website to be placed at the top of a list of search results displayed to the user. The pay-for-placement bids may be either in the form of a flat amount of money (e.g., $1,000) or in the form of a portion of the discount offered to the user. For example, if the vendor offers a ten dollar discount to the user, the user will receive five dollars off the goods or services of the vendor, while the search engine will receive the remaining five dollars as a commission for the sale. Alternatively, a “hybrid” bidding system can be employed where the vendor can bid a certain flat rate of money to have their commercial offer displayed prominently in the search results, and can have a portion of the discount paid to the search engine as an additional commission. Any combination of flat rate payments and portions of discounts can be employed without departing from the spirit and scope of the present invention.

Although FIGS. 3 and 6 illustrate vendor bids being received after the target area has been established, the vendor bids can be solicited at any time. For example, the vendors can be asked to bid within a pay-for-placement methodology for future unknown consumers, well before any target area has been determined (i.e., prior to S305 in FIG. 3). Alternately, vendor bids can be solicited only when a user enters a search query into a search engine and where the vendor's business website appears in search results. The vendor can automate this process such that vendor bids are automatically provided to the pay-for-placement auction if a user's target area and the search results include the vendor's website. Also, the vendor can vary the pay-for-placement bid based on where the vendor's business is located within the target area (e.g., in the middle of the target area or on the outskirts) or based on historical information of the consumer (e.g., the consumer's propensity to shop with the vendor).

Following S610, the process proceeds to S620 where the user device 100, the server 105 or another device or system on the network 110 determines whether bids have been received in accordance with the pay-for-placement methodology. For example, if the user searched for Italian restaurants, and several bids have been received for Italian restaurants within the user's target area, the offers will be displayed in an order corresponding to the bids received, as depicted in S625. Otherwise, the process proceeds to S630 if no bids have been received for the user's search term, and offers are displayed in an order based on the proximity of the business to the user's current location.

Following steps S625 and S630, the user has now obtained the commercial offers from vendors from within his or her target area, and the offers have been displayed or other presented to the user. Accordingly, vendors waste less money on pay-for-payment bids directed at consumers that are unlikely to conduct business with the vendor. Also, the user now has the ability to accept commercial offers within his or her target area and is not inundated with commercial offers from businesses located outside of his or her target area that would be impossible or inconvenient to accept or use.

FIGS. 7(a)-(c) shows a display of a map with specific geographic points of interest chosen manually by a user. As shown in FIG. 7(a), in this example, the user lives in the Chicago metropolitan area, and has manually chosen the Lincolnwood area as the location of his or her home. The process then prompts the user to input the location of his or her place of business, which is in the downtown loop area of Chicago, as shown in FIG. 7(b). The user can then input any other location as a geographic point of interest, e.g., the school of the children of the user, as shown in FIG. 7(c).

As shown in FIG. 8(a), the user can modify the target area by using an input device (e.g., a computer mouse) and dragging the default radius, shape and/or size on any one of the geographic points of interest. As shown in this example, the user has decided to modify the target area associated with the user's work. The user has decided to shrink the target area surrounding this geographic point of interest to exclude the southern end thereof, which the user is less likely to be on a regular basis. Of course, any other modifications, including enlarging and shrinking the target area or modifying the shape, can be performed by the user based on any factor the user deems relevant. As shown in FIG. 8(b), the target areas surrounding the geographic points of interest have merged in accordance with the factors determined in S310 to form a custom target area for the individual user.

It is noted that many of the above examples provide a target area associated with the user's home and work locations, which would generally be located within the same metropolitan area. However, the user may create a separate profile for a separate metropolitan area, e.g., if the user has a vacation home in another metropolitan area. For example, if the user lives in Chicago, but regularly vacations in Miami, the user may create a separate profile for his or her Miami home with its own set of geographic points of interest and its own target areas. The separate profile can temporarily replace and suspend the original target area or can maintain both of the target areas simultaneously. By suspending the original target area, the user can avoid receiving commercial offers from within his or her regular shopping area while temporarily absent.

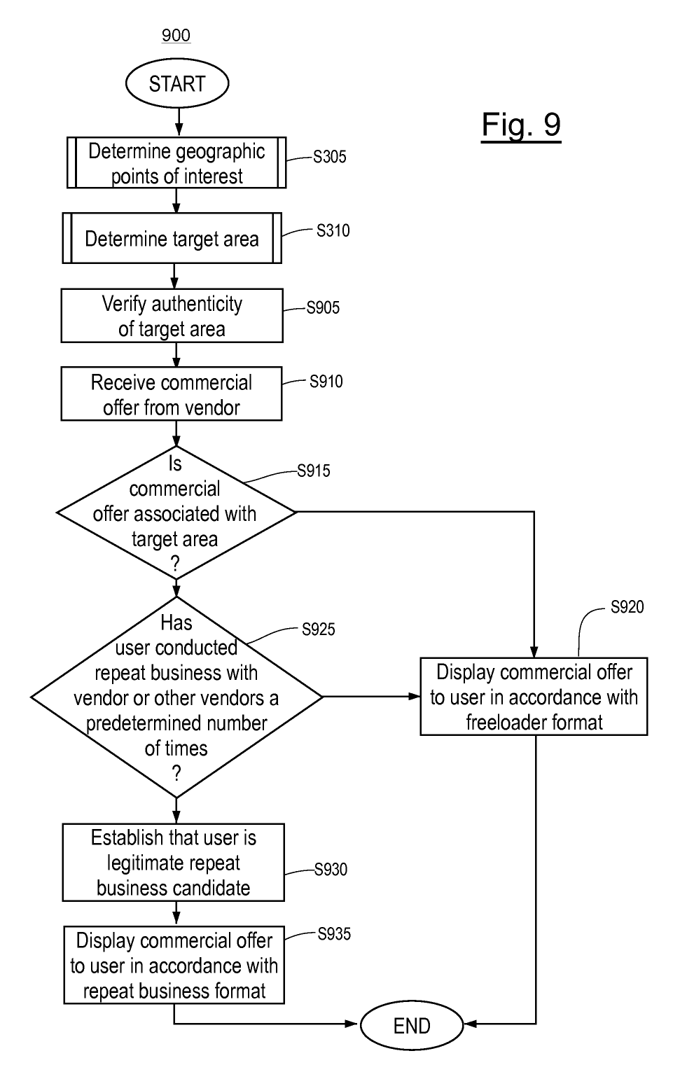

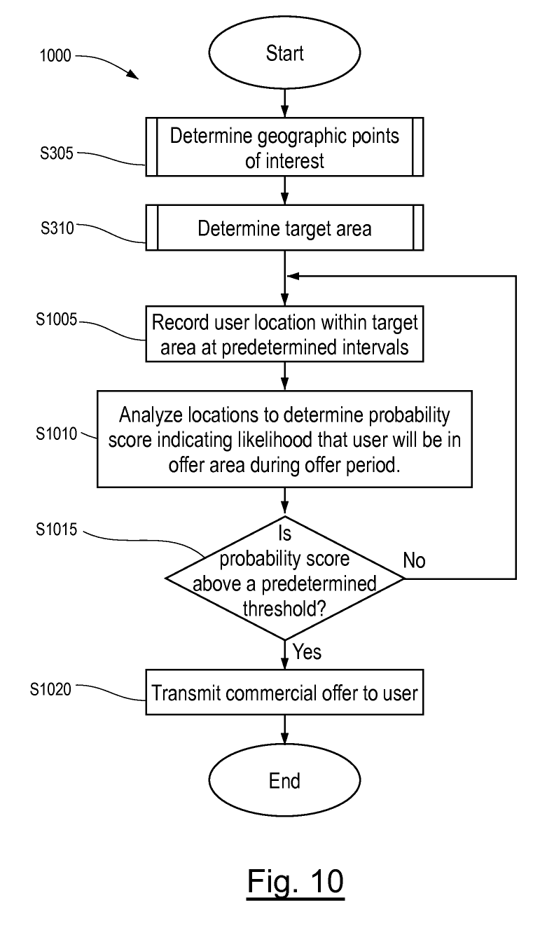

FIG. 9 illustrates an embodiment of the present application where a method, apparatus or computer program can be used to establish whether a user will likely conduct repeat business with a vendor presenting a commercial offer to the user. For example, when a vendor offers a commercial offer to a potential customer, typically in the form of a discount or other incentive, the main purpose of such offering is to entice the potential customer to the vendor's establishment to try the vendor's goods or services, with the hope that the user will be happy with the goods or services received through the offer and return to the vendor in the future without the enticement of additional commercial offers. Accordingly, while the vendor may lose money by honoring the initial offer to the customer (e.g., if the offer is for buy one, get one free, the vendor must pay for the product that was provided for free), the commercial offer is a premise for repeat, future business of the customer. However, if a potential customer is not likely to frequent the vendor's establishment in the future, the vendor may lose money by honoring the offer with the customer, without any likelihood of repeat, future business from that customer.

Accordingly, in an embodiment of the present application, if the system determines the user is likely to conduct repeat business with the vendor by being located near the vendor or based on other factors, the system will present the offer in a first format. If, on the other hand, the system determines the user is less likely do conduct repeat business with the vendor, such as if the user does not reside or typically travel near the vendor, the system will present the offer in a second format. In the second format, the offer is more expensive for the potential customer, or less prominently displayed, or is limited to a shorter time span as compared to the first format to provide additional incentive for the user to conduct repeat business with a vendor when a vendor presents a commercial offer.

The process disclosed herein is advantageous because it identifies “freeloaders” who receive online coupons or other commercial offers, and use those offers, but conduct little or no repeat business with the vendor presenting the commercial offer. The present application thus discloses a process by which “freeloaders” are identified as users that have a low likelihood of conducting repeat business, either because of the target area of the consumer, the buying habits of the consumer, or any other factor relevant in predicting the buying potential of a selected consumer.

As shown in FIG. 9, the process 900 starts similar to the process of FIG. 3, where the system determines at least one geographic point of interest of the user S305 and a target area S310 of the user. Following these steps, the process 900 then verifies the authenticity of the target area S905 based on user authentication. For example, if the user's home address was input as the geographic point of interest, the process 900 can prompt the user to enter a credit card number or some other type of identification to verify that the home address is accurate. Alternately, a certified letter may be sent to the user to verify the user's home address. The user could also transmit information or have information transmitted from a utility account (e.g., an account with a gas or electricity company) under the presumption that such information reflects an accurate user address.

A shopping area can also be validated by using GPS functionality, where a mobile phone application can record the GPS coordinates of a user at predetermined or user-designated times. The GPS recording may be stronger in an area that is frequently visited by the user, and vendors can use this information to provide better coupon discounts to users who have an increased presence in the location of the vendor in that area. For example, a user that is frequently located near a specific restaurant may receive a better discount offer for that restaurant based on the GPS recording the increased frequency of the user in that area. The user can either receive a custom discount offer or be included within a specific group of users that have a predetermined presence near the restaurant, for example. Vendors can increase, decrease, or eliminate the discount based on any factor they deem relevant to the purchasing habits of the users. Any other manner of verifying the target area can be implemented without departing from the spirit and scope of the present application.

Once the target area is verified, a geographically relevant commercial offer S910 is transmitted to the user. That is, the user can request a commercial offer from a server or the server can transmit the geographically relevant commercial offer at a predetermined date and time without separate user requests. Once the commercial offer is received, the system determines whether the commercial offer is from a vendor associated with the target area of the user S915 as a means for determining whether the user is likely to conduct repeat, future business with the vendor presenting the commercial offer. The term “associated with” is not intended to limit the scope of the invention to only those vendors physically located within the target area, but can include vendors that advertise within the target area, provide electronic commerce services or goods to the target area, or otherwise have a presence within the target area.

In step S910, commercial offers can be transmitted to users in a time-released fashion so as to provide a sustainable form of business for the vendor. For example, coupons or advertisements can be transmitted to a subset of users where the exact price and amount of products sold are determined prior to the deal being announced to the customers. Rather than transmitting the deal to all of the potential customers at the same time, the time-released deal system transmits the deal separately to small groups of customers over a period of time in step S910. The vendor is less likely to be overwhelmed with the influx of business and will avoid personnel or inventory issues associated with the extra business.

Step S915 can identify a “freeloader” who is likely to travel outside of their normal shopping area simply to take advantage of a commercial offer providing a discount or coupon, and, therefore, has little prospect to conduct repeat, future business with the vendor. Thus, if the commercial offer is associated with a vendor located outside of the verified target area, the process can proceed to step S920 where the commercial offer is displayed to the user in a first format designating the consumer as a “freeloader,” as will be discussed below in more detail. If the commercial offer is within the verified target area, the process proceeds to step S925.

For the time-released deal system, step S915 can require the user refer the deal to a predetermined number of other customers before the user can be eligible for the deal. Accordingly, the user can be designated as a freeloader if a predetermined number of referrals are not met, or can be transmitted the commercial offer if the user refers a specified number of users to the vendor or commercial offer.

In step S925, the process 900 determines whether the user has previously conducted repeat business a predetermined number of times with the vendor presenting the commercial offer or with other vendors within the verified target area. Step S925 can obtain information from a server or other electronic storage that identifies the past commercial offers used by the user and the extent of repeat business conducted by the user with the vendor presenting the commercial offer subsequent to the commercial offer. Thus, prior to S925, the user's prior commercial interactions with vendors can be recorded. The consumer's past commercial behavior can then be used to predict likely future consumer behavior when the user obtains the commercial offer.

In an embodiment, step S925 determines whether a user has conducted repeat business a predetermined number of times, but it is to be appreciated that new users may be exempt from this scrutiny. For example, a user that has used the system sparsely may have only a few commercial transactions in which a commercial offer was received, and the user may have decided that the product or service received by the user was not up to the user's standards. In this embodiment, the system may trigger the step of S925 after a predetermined number of commercial transactions are conducted by the user. For example, the system may require the user to conduct ten or more user transactions using commercial offers from the vendor before designating a user as a “freeloader.” Such a buffer avoids improperly punishing users that are simply new to the system or who purchased goods or services through the commercial offers that did not meet the user's expectations.

Following step S925, the process either establishes that the user is a likely “freeloader” and proceeds to step S920, or establishes that the user is a likely legitimate repeat business candidate S930, and proceeds to step S935. In step S935, the commercial offers are presented to the user in a repeat business format that is preferable, from the user's standpoint, to the freeloader format of S920. That is, the legitimate repeat business candidate format can present higher discount commercial offers, commercial offers with later expiration dates, or can simply display the commercial offers more prominently to the user if the user is predicted to be a legitimate repeat business candidate. For example, the commercial offer can be displayed higher on a list of search results, or can be displayed in brighter or more noticeable colors. Any other way of presenting the legitimate business format offer in a format preferable to the freeholder formatted offer can be utilized without departing from the spirit and scope of the present application. Once the commercial offer is presented to the user in either step S920 or S935, the process ends.

The matter set forth in the foregoing description and accompanying drawings and examples is offered by way of illustration only and not as a limitation. More particular embodiments have been shown and described, and it will be apparent to those skilled in the art that changes and modifications may be made without departing from the broader aspects of Applicant's contribution. The actual scope of the protection sought is intended to be defined in the following claims when viewed in their proper prospective based on the prior art.

1. A method of presenting a commercial offer to a user comprising:
establishing a geographic point of interest of the user;
determining a target area of the user based on the geographic point of interest;
collecting a commercial offer from a vendor;
determining, by a processor, whether the vendor of the commercial offer is associated with the target area;
presenting the commercial offer to the user in a first format only if the vendor is associated with the target area, and presenting the commercial offer in a second format only if the vendor is not associated with the target area.

2. The method of claim 1, wherein the commercial offer is a coupon.

3. The method of claim 1, further comprising verifying the target area.

4. The method of claim 3, wherein the step of verifying the target area includes one or more of sending a certified letter to the user, obtaining identification information of the user from the user, obtaining identifying information of the user from a utility organization doing business with the user, and recording GPS coordinates of the user to establish areas where the user is located at a designated time.

5. The method of claim 3, further comprising:
recording commercial transactions of the user when the user receives the coupon;
determining whether the user previously conducted business with the vendor a predetermined number of times when the user is provided with the coupon;
presenting the commercial offer to the user in the first format if the vendor is associated with the target area and if the user previously conducted business with the vendor the predetermined number of times after the user is provided with the online coupon; and
presenting the commercial offer to the user in the second format if the user has previously conducted business less than the predetermined number of times after the user is provided with the online coupon.

6. The method of claim 1, wherein the first format displays includes a first price, and the second format includes a second price, wherein the first price is less than the second price.

7. The method of claim 1, wherein the first format displays the commercial offer higher on a list as compared to the second format.

8. An apparatus for receiving a commercial offer from a vendor comprising:
a computer-readable medium adapted to store data;
a processor adapted to execute a computer program that determines a target area of a user based on at least one of a geographic point of interest input by the user and a geographic point of interest determined by the computer program;
a transceiver adapted to receive information identifying the target area from an external server and receive a transmitted commercial offer from the server, wherein the commercial offer is from a vendor associated with the target area; and
a display adapted to present the commercial offer to the user,
wherein the processor is adapted to cause the transmission of the commercial offer to the user in a first format only if the vendor is associated with the target area, and cause the transmission of the commercial offer in a second format only if the nevdor is not associated with the target area.

9. The apparatus according to claim 8, further comprising verifying an authenticity of the target area.

10. The apparatus according to claim 9, wherein the step of verifying the target area includes one or more of sending a certified letter to the user, obtaining identification information of the user from the user, obtaining identifying information of the user from a utility organization doing business with the user, and recording GPS coordinates of the user to establish areas where the user is located at a designated time.

11. The apparatus according to claim 8, wherein the commercial offer is a coupon.

12. The apparatus according to claim 11, wherein one of the server and the computer-readable medium is adapted to record commercial transactions of the user when the user receives the coupon, and is further adapted to determine whether the user previously conducted business with the vendor a predetermined number of times after the user is provided with the online coupon;
wherein the processor is adapted to:
present the commercial offer to the user in the first format only if the vendor is associated with the target area and only if the user previously conducted business with the vendor the predetermined number of times when the user is provided with the online coupon, and
present the commercial offer to the user in the second format only if the user previously conducted business with the vendor fewer than the predetermined number of times after the user is provided with the online coupon.

13. The apparatus according to claim 8, wherein the first format includes a first price, and the second format includes a second price, wherein the first price is less than the second price.

14. The apparatus according to claim 8, wherein the first format displays the commercial offer higher on a list as compared to the second format.

15. A method of presenting commercial offers from a vendor to a user comprising:
allowing the user to request a first commercial offer from a server;
recording whether the user conducts business a predetermined number of times with the vendor after receiving the first commercial offer;
allowing the user to request a second commercial offer from the server after the user requests the first commercial offer from the server;
causing, by the server, the delivery of the second commercial offer to the user in a first format only if the user previously conducted business with the vendor the predetermined number of times after receiving the first commercial offer, and causing, by the server, the delivery of the second commercial offer to the user in a second format only if the user previously conducted business with the vendor less than the predetermined number of times after receiving the first commercial offer.

16. The method of claim 15, further comprising verifying an authenticity of the user.

17. The method of claim 16, wherein the step of verifying the authenticity of the user includes one or more of sending a certified letter to the user, obtaining identifying information from a card of the user, obtaining identifying information from a utility organization doing business with the user, and recording GPS coordinates of the user to establish areas where the user is located at a designated time.

18. The method of claim 15, wherein the commercial offer is a coupon.

19. The method of claim 15, wherein the first format includes a first price, and the second format includes a second price, wherein the first price is less than the second price.

20. The method of claim 15, wherein the first format displays the commercial offer more prominently compared to the second format.

21. A method of presenting a commercial offer to a user comprising:
establishing a geographic point of interest of the user by allowing the user to input geographic locations into a database;
determining a target area of the user based on the geographic point of interest;
collecting a commercial offer from a vendor;
determining, by a processor, whether the vendor of the commercial offer is associated with the target area;
presenting the commercial offer to the user in a first format only if the vendor is associated with the target area, and presenting the commercial offer in a second format only if the vendor is not associated with the target area; and
verifying the target area by a member including one or more of sending a certified letter, obtaining identifying information from a card of the user, and obtaining identifying information from a utility organization doing business with the user.
